(19) United States
(12) Patent Application Publication
(10) Pub. No.: US 2009/0210388 A1
(43) Pub. Date: Aug. 20, 2009

(54) EFFICIENTLY DISCOVERING AND SYNTHESIZING MAPS FROM A LARGE CORPUS OF MAPS

(75) Inventors: Jeremy E. Elson, Kirkland, WA (US); Danyel A. Fisher, Seattle, WA (US); Jonathan R. Howell, Seattle, WA (US); Miguel Elias, Santiago (CL)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/034,029

(22) Filed: Feb. 20, 2008

(51) Int. Cl. G06F 7/06

(52) U.S. Cl. 707/3; 707/E17.014

(57) ABSTRACT

Intent of a user is determined with respect to mapping information. A search is performed for relevant maps from a plurality of disparate sources. A subset of maps from a superset of available maps are identified that correlate to the determined intent, and the subset of maps are fused or synthesized to create a single map view that aggregates and combines relevant content from respective maps of the subset.

### BACKGROUND

Over the past few years, there has been an explosion of interest in utilizing web-based tools for visualizing geographic data. While computerized geographic information systems (GIS) tools have been available for decades, price and sophistication thereof has limited employment of such tools to specialized markets. Online map portals targeted at consumers (e.g., Google Maps, Microsoft Virtual Earth, Yahoo! Maps) have begun to offer simple, public programming interfaces, putting a core set of useful GIS tools into hands of a large audience of non-specialists. Geographic “mash-ups” have become commonplace, typically relating third-party content with the mapping portal's standard road maps and aerial photography. Web sites abound in stunning variety: interactive maps annotated with local gasoline prices, reported crimes, real estate prices, amateur weather observations, bus routes, bicycle trails, and so forth.

Most existing web applications place a single form of data (e.g., gasoline prices) over a single standard map layer (e.g., road map). Some interfaces have begun to introduce layers: annotations that can be turned on and off individually, and synthesized into a single display. Current interfaces both in consumer tools and professional GIS products can support selection of a few layers from among several, by utilizing a file system or a checkmark list of prepared overlays. However, they are targeted toward users who have a small set of layers that they are familiar with, such as for example maps they have created or are based on familiar data.

Existing interfaces work well when there are just a few layers to choose from. But one now has the ability to share thousands of maps from distributed sources on the Internet, as well as via on-line access to libraries. Map archives are being scanned and a variety of organizations are making their maps available. Identifying, and utilizing these available maps in a meaningful manner is a daunting challenge.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The subject innovation provides rich tools for determining intent of a user with respect to mapping information, for example, identifying a subset of maps from a superset of available maps that correlate to the determined intent, and synthesizing the subset of maps to provide a meaningful mapping experience to a user via synergies associated with creating a single map view that aggregates and combines relevant content from respective maps of the subset of maps.

In one exemplary non-limiting embodiment, a query (e.g., from a user or machine) is received and analyzed to determine or infer intent. A superset of indexed maps are searched (e.g., a database, set of databases, the Internet, a network, . . . ) to identify a subset of maps from such corpus of maps that are relevant to the determined or inferred intent. The subset of maps is synthesized to create a view of map information that combines features from respective maps of the subset to generate a meaningful display of map information that is a function of the intent.

Other embodiments relate to filtering maps as a function of intent and location, providing a filtered set of map images as a series of thumbnails to a user, filtering, combining, and presenting maps as a function of scale of view, or animating subsets of maps.

The following description and the annexed drawings set forth in detail certain illustrative aspects of the claimed subject matter. These aspects are indicative, however, of but a few of the various ways in which the principles of such matter may be employed and the claimed subject matter is intended to include all such aspects and their equivalents. Other advantages and novel features will become apparent from the following detailed description when considered in conjunction with the drawings.

### BRIEF DESCRIPTION OF THE DRAWINGS

FIGS. 1-3 illustrate block diagrams of system embodiments that identify and combine maps.

FIGS. 4 and 5 schematically illustrate examples of filtering, synthesizing, or fusing maps.

FIGS. 6 and 7 illustrate example task classification in accordance with aspects of the subject innovation.

FIGS. 8-10 illustrate methodologies in accordance with aspects of the subject innovation.

FIG. 11 corresponds to empirical data based on discussions with a plurality of map experts.

FIG. 12 illustrates a browser interface in accordance with an aspect of the subject innovation.

FIG. 13 illustrates a methodology in accordance with aspect(s) of the subject innovation.

FIG. 14 illustrates a block diagram of a system embodiment in accordance with aspect(s) of the subject innovation.

FIG. 15 illustrates an exemplary operating environment that can be employed in accordance with the claimed subject matter.

FIG. 16 illustrates an exemplary networking environment, wherein various novel aspects of the claimed subject matter can be employed.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers. The word “exemplary” is used herein to mean serving as an example, instance, or illustration. Any aspect or design described herein as “exemplary” is not necessarily to be construed as preferred or advantageous over other aspects or designs.

Furthermore, aspects of the claimed subject matter may be implemented as a method, apparatus, or article of manufacture using standard programming and/or engineering techniques to produce software, firmware, hardware, or any combination thereof to control a computer to implement various aspects of the subject invention. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips, optical disks (e.g., compact disk (CD), digital versatile disk (DVD), . . . ), smart cards, and flash memory devices (e.g., card, stick, key drive, . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of what is described herein.

For purposes of explanation and not limitation, the systems and/or methods are generally described herein with respect to maps. However, it is to be understood and appreciated that concepts underlying the following description can be applied to other areas where value of information is important. Therefore, the following description is not intended to be limited to just the field of maps.

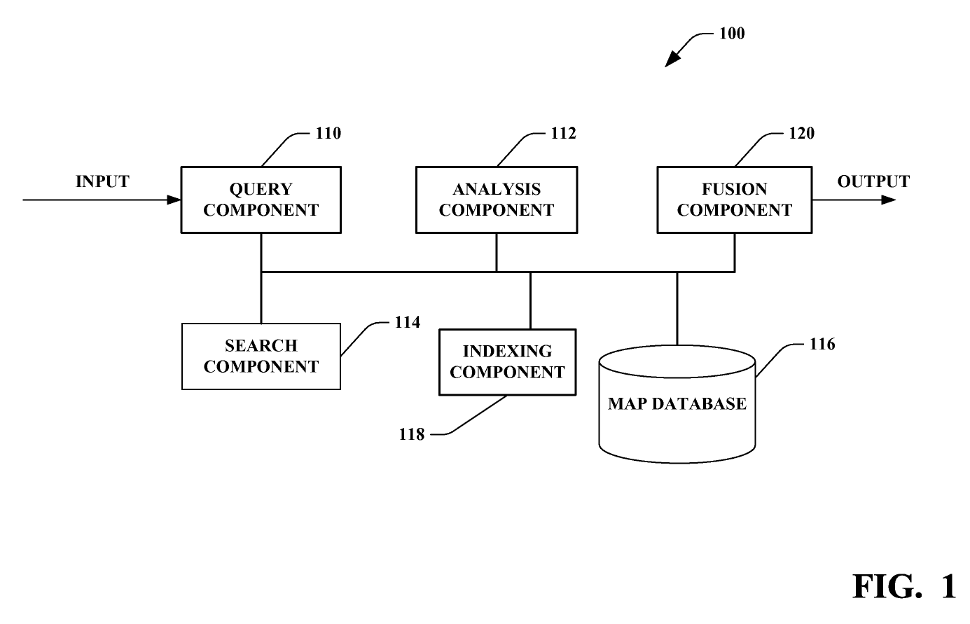

FIG. 1 illustrates an embodiment of a system 100 that leverages off of numerous maps that may be available from disparate sources. An input (e.g., user or machine input) is received by a query component 110. The query component parses the input, and for example generates structured search string(s) in connection with locating maps relevant to the query. An analysis component 112 analyzes the input or the reformulation thereof and determines or infers intent with respect to the input. It is to be appreciated that extrinsic data (e.g., historical information, user preferences, user context, environmental data, . . . ) can be employed by the analysis component 112 in connection with determining or inferring intent. A search component 114 executes a search for maps relevant to the analyzed input or query. The search can be performed across a database, multiple databases, the Internet, an intranet, a network, a device, a set of devices, etc. A map database 116 is shown to represent any or all of the aforementioned sources of map information as well as any other suitable source for map information. An indexing component 118 indexes respective sources of map information to facilitate accurate and efficient retrieval of map information. It is to be appreciated that the indexing component can include or leverage web crawling technology.

A large corpus of maps can be searched across, and analyzed in connection with identifying a subset of maps that are relevant to the determined or inferred intent. A fusion component 120 can aggregate or synthesize the subset of maps or respective features thereof to generate a mapping view that combines aspects of the respective maps to create a meaningful mapping experience for a user that leverages off the combination of maps.

The following examples are provided to facilitate understanding some of the powerful aspects of the embodiments described herein. In one particular example, a user intends to take a tour of San Francisco, and he provides the following input: “Walking tour of historical sites in San Francisco”. The system 100 analyzes this input and determines that the user plans on walking through the streets of San Francisco and is interested in historical sites. Based on the user's historical searches and preferences, the system augments the search query to up-weight maps that have information related to historical buildings of architectural significance. A subset of maps is found that the system has identified as having high probability of relevance to the user's intent. One of the maps is a walking tour map of San Francisco that has received high frequency of downloads and high ratings by users interested in walking tours. Another map relates to historic homes in the Bay area that are of architectural appeal. Another map relates to architectural landmarks (e.g., Pan America building, Westin St. Francis hotel, Golden Gate bridge, Coit tower . . . ). The system optionally can obtain and cache numerous additional maps (e.g., restaurant locations, shopping locations, taxi pick-up areas, hotels . . . ) that may be relevant to the user during the walking tour. The maps are dynamically fused to generate a single view that combined features from the maps. It is to be appreciated that a variety of techniques can be employed in connection with such fusing or synthesis process. For example, the maps can be overlaid upon another, and opacity or transparency techniques can be employed to display relevant content. The maps can be stitched together to form an aggregated map of content. Content from the respective maps can be selectively masked or exposed as a function of user state, context, preferences, device type, device capabilities, or the like.

Furthermore, the system 100 can migrate from one device to another, or be deployed on multiple devices that synchronize or hand-off duties. In one example, the user can initially input the walking tour query on a desktop computer. However, it is not feasible for the user to carry the desktop computer on the tour. Accordingly, the system 100 can transfer function to a mobile device (e.g., cell phone, personal data assistant, laptop . . . ).

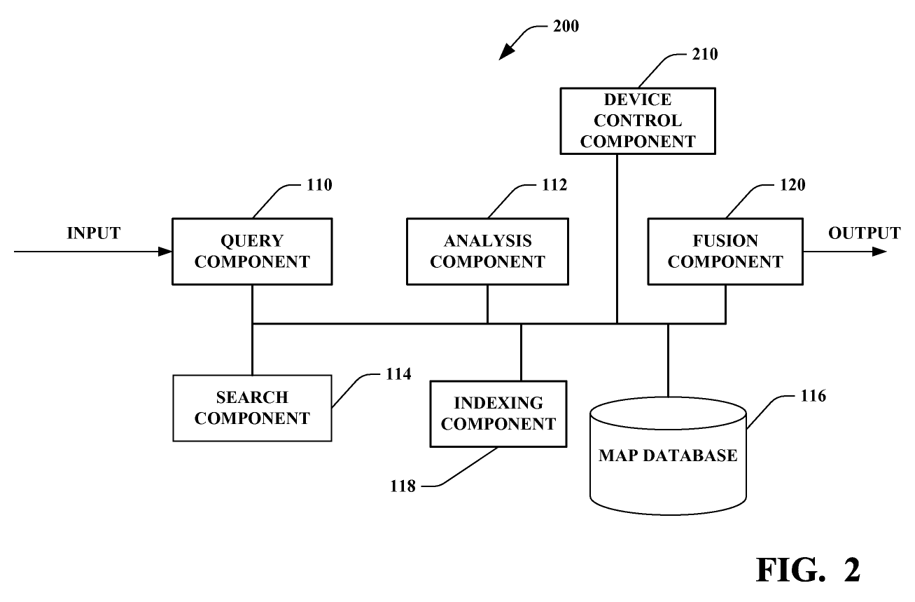

FIG. 2 illustrates an embodiment system 200 that includes a device control component 210. It should be noted that repeated or redundant discussion of like components between various embodiments described herein is omitted for sake of brevity. The device control component 210 identifies type and capabilities of devices that are, may, can, or will be used in connection with system 200. Thus, as a user shifts from employing a desktop computer to a mobile device, the system adapts to enhance or optimize a mapping experience given respective device capabilities. Portable devices often have limited screen real estate, and thus the system 200 can limit presentation of information in accordance with determined or inferred current user intent as well as relevance to current user or device state. For example, a map view can be presented to a user of a walking tour, which allows the user to view the tour at multiple levels of granularity (e.g., different levels of zoom as well as detail). As the user walks out of his hotel, a map of the general area around the hotel can be presented (e.g., 1-2 city blocks) with the sidewalks to travel for the tour high-lighted. Points of historical architectural interest within such area can be exposed or masked as a function of the state or context information discussed supra.

Out of the subset of maps employed to affect the viewing experience, some maps can be weighted or ranked as more relevant than others. Continuing with the above example, the sidewalk map is deemed most relevant since this will guide the user through the walk; and the maps of historical sites are classified as secondary to the sidewalk map. Likewise, tertiary maps (e.g., restaurants, shopping, bars, roads, site-seeing, cultural . . . ) can be prioritized lower than the primary or secondary maps, and so on.

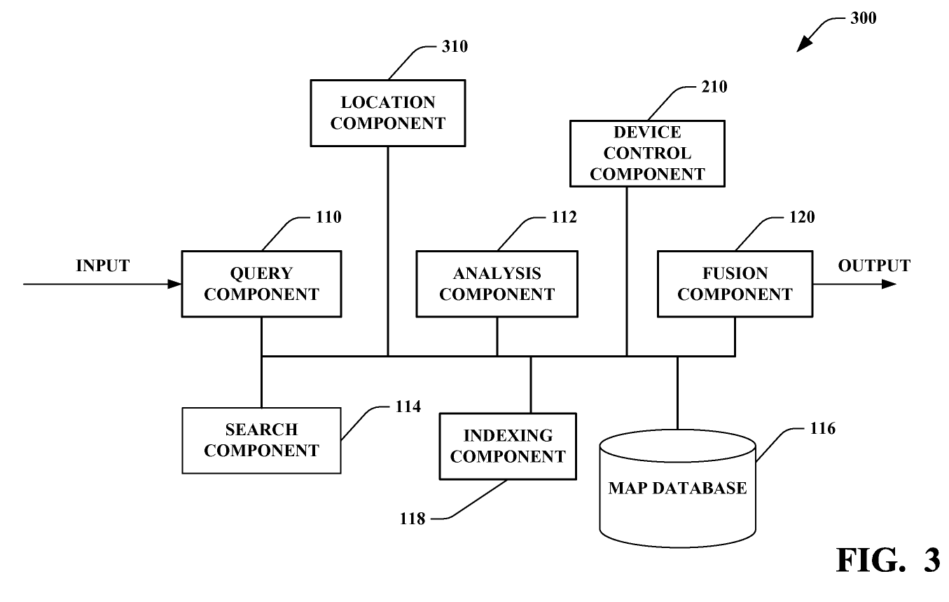

FIG. 3 illustrates an embodiment of a system 300 that includes a location component 310. As can be appreciated, location information is a significant metric employed in connection with maps. Current location, past and future locations, for example, are relevant to decision-making in connection with which maps to utilize as well as portions thereof. Many devices and vehicles are equipped with location-based technology that facilitates identifying location associated with a user. The location component 310 for example can utilize global positioning system (GPS) technology, wireless technology for identifying location, proximity sensing, geo-tags, user input, inferring location based on extrinsic data, and other technologies suitable for determining or inferring location. System 300 can employ such location information to facilitate selecting most appropriate maps to employ in connection with generating a map(s) view. For example, respective portions of a set of maps can be fused as a function of location. Location information can be employed in connection with scaling of maps as well. Moreover, speed of travel can also be used in connection with fusing maps as well as pre-fetching or fusing other portions for expected use in the upcoming future (e.g., based on current location and velocity of travel various maps can be pre-selected, combined and cached for seamless presentation of maps(s) display). It is to be appreciated that in certain embodiments, location information can refer to user or device physical location, user or device view context location, virtual location, relative location, or the like.

It is to be appreciated that embodiments described herein can triage various modalities or functionalities in connection with enhancing user experience. For example, if screen real estate is limited, certain map information that is not amenable for display can be conveyed by audio to augment the map experience. In another example, if a user is running or driving under conditions where viewing a display is not suitable, the system map information can be dynamically switched from display mode to pure audio mode (e.g., instructions or commentary can be provided by audio as the user is running along a route, content of interest can be provided to the user as he approaches a point of interest, amount and rate of content can be dynamically adjusted as a function of speed, cognitive load, interest, etc.).

Various embodiments described herein can utilize probabilistic models in determining value for a map or section thereof. One of several discriminative or generative statistical methods can be employed for prediction and forecasting over time. These methods include statistical classifiers such as support vector machines, the use of Bayesian structure search within the realm of Bayesian machine learning, the learning and usage of dynamic Bayesian networks and related Hidden Markov Models, Continuous Time Bayesian Networks (CTBNs), and families of time-series methods such as those employing temporal Bayesian models, and models known as ARMA and ARIMA forecasting models.

Such embodiments can generate context specific utility values. The utility value corresponding to a map or section can vary depending upon context. For example, during morning rush hour, data associated with a section of inbound lanes of traffic on a major highway can have a relatively high utility value. However, in the evening, flow of traffic is generally reversed. The same section of inbound lanes of the major highway is unlikely to provide information regarding bottlenecks. Consequently, the utility value associated with the section for evening rush hour should be correspondingly low. Other contextual information such as construction or weather conditions can also affect valuation of a section. Sections road prone to flooding can have high valuations during rainstorms, and significantly lower valuations during droughts. Utility values can vary based upon day of the week, weather conditions or any relevant other contextual data.

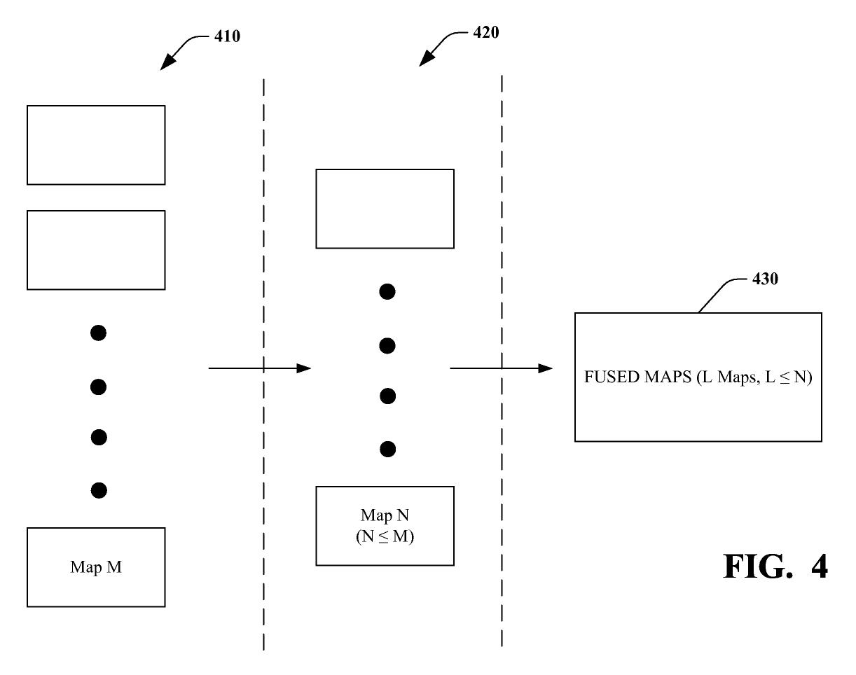

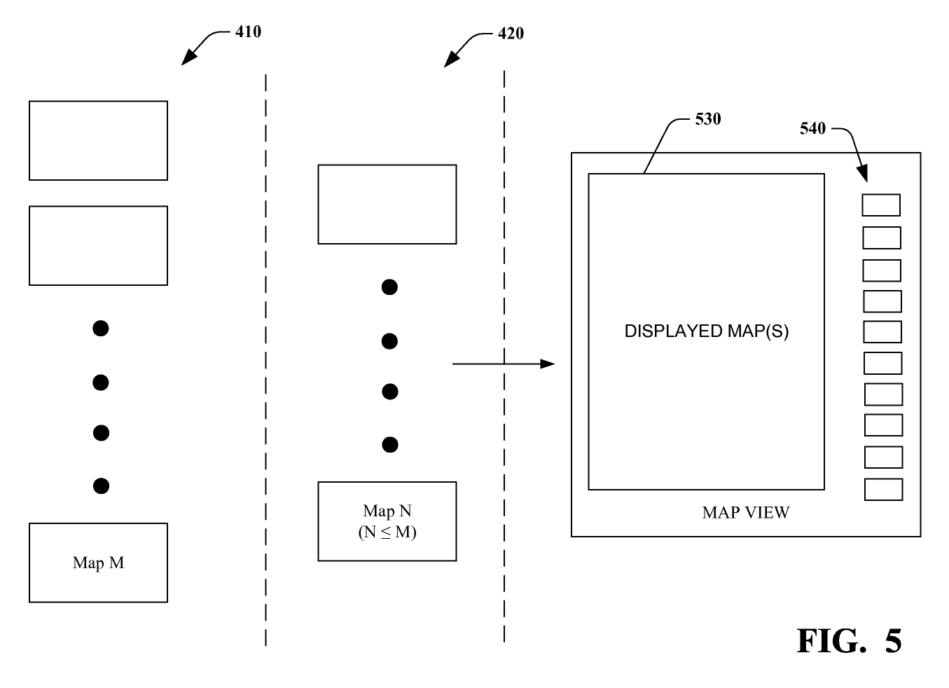

FIGS. 4 and 5 schematically illustrate examples of filtering, synthesizing, or fusing maps. In FIG. 4, at 410 a set of M maps (M being an integer) are identified in connection with a search. At 420, the M maps are filtered to a subset thereof of N maps (N is an integer ≦M). At 430, L maps (L is an integer ≦M) are fused to generate an aggregated map that combines features of the respective L maps to provide a rich map view that satisfies a user's information needs. It is to be appreciated that this process can be dynamic (as well as run as a background process) where filtering of the M to N maps, or N to L maps is occurring continuously or at various intervals or frequencies so as to for example update the map view as a function of change in state, context, or intent.

FIG. 5 illustrates an aspect where a subset of the L maps are presented in a display 530, and some or all of the L maps are also displayed as thumbnail views 540. In such embodiment, an aggregated view of a set of maps can be viewed at 530 as well as a single view. Moreover, as a user pans over respective thumbnails, the panned over or thumbnail of interest can be viewed at 530, or combined with another map to generate an aggregated view. The user can select from a variety of functions such as for example: (1) selecting a set of thumbnails to view corresponding maps as an aggregated; (2) selecting a thumbnail to have the corresponding map overlaid over, or integrated with another map; (3) changing opacity or transparency of features of one map with respect to another map; (4) filtering on certain criteria across a set of maps or thumbnails thereof; (5) designating features associated with a subset of maps or thumbnails to be conveyed in a different modality (e.g., audio, image, text, . . . ) than another set of maps or thumbnails.

Many conventional map systems are pre-populated with maps specifically created for a respective system as well as vertical domain (e.g., real estate, driving, shopping . . . ). These systems cannot leverage the thousands of legacy maps that are available let alone newly created maps not specifically designed for a particular system. Embodiments herein provide for utilizing digitized versions of legacy maps to exploit information provided there from. The legacy maps can be manually or machine tagged with metadata corresponding to aspects/features thereof. Information such as scaling, content, context, accuracy, age, creation date, last updated, author, comments, etc. can be embedded or associated with the digital versions of these maps. Moreover, schemas can be provided that allow authors to generate or modify maps so as to be in conformity with other maps as well as fused or integrated therewith. In other embodiments, wiki-type platforms can be provided that allow for such maps to be updated or augmented by a global audience.

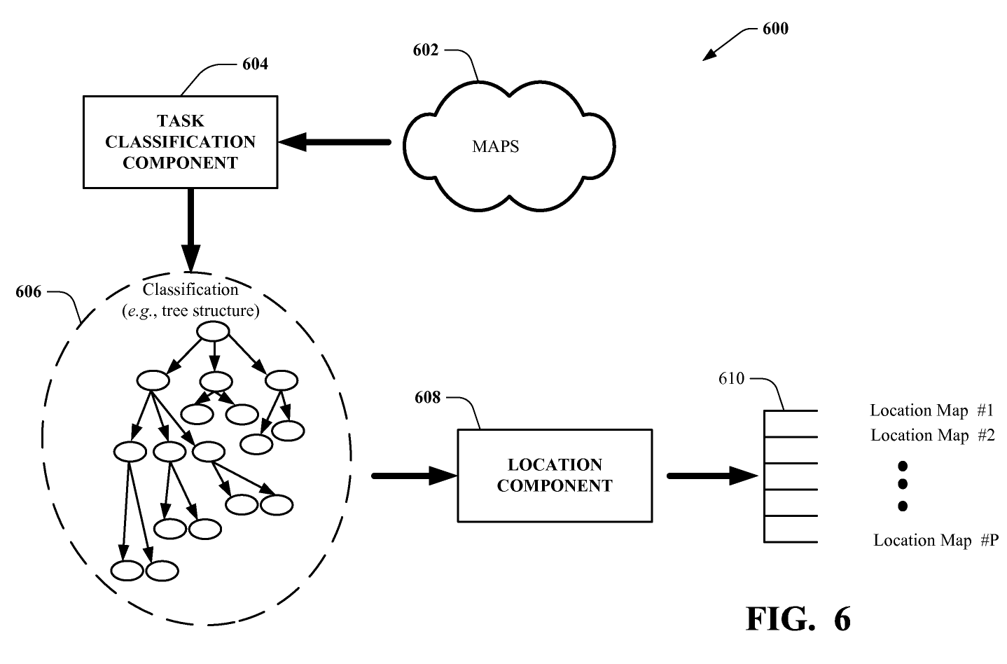

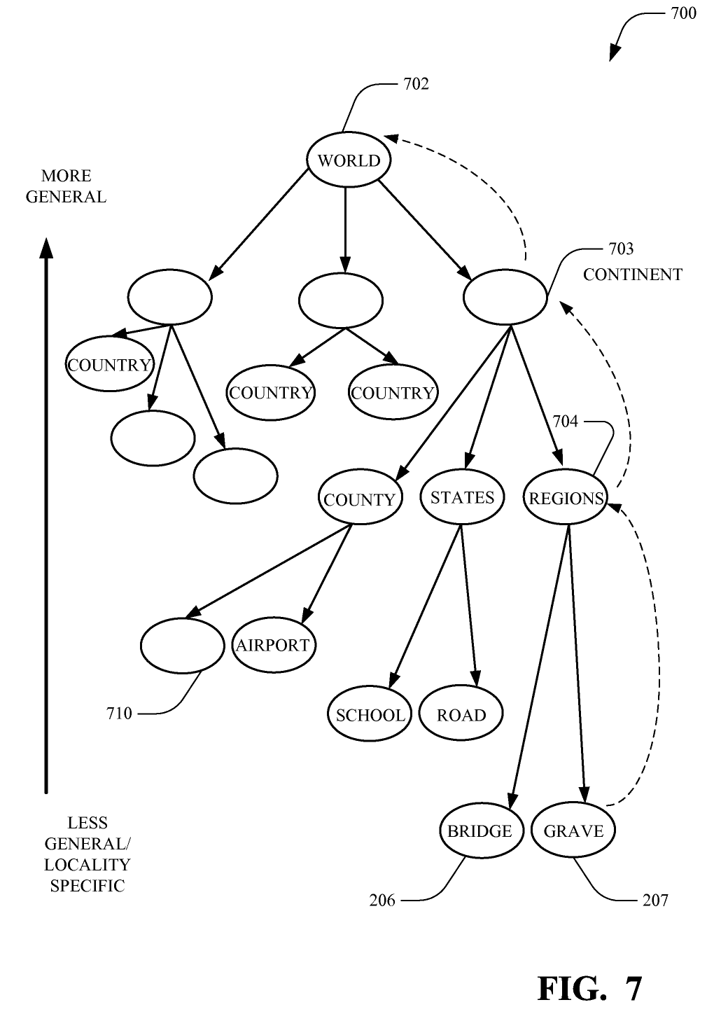

FIG. 6 illustrates a system 600 that includes a task classification component 604 that analyzes a set of maps 606 and generates a classification 606 (e.g., a tree structure). Although this embodiment is described within the context of a tree-type classification, it is to be appreciated that any suitable classification scheme in accordance with embodiments described herein can be employed. As described in more detail infra the classification can be such that maps are classified into classes of familiarization, evolution, and fusion. The classification can also be along various axes as described in greater detail below. A location component 608 is provided which as shown seen in FIG. 7 can identify and scale locations. The location component 608 along with the map classification 606 can generate a list or series of maps 610 for particular location(s), e.g., location map #1, location map #2 . . . location map #P (where P is an integer). In one exemplary non-limiting embodiment, the maps are utilized with a web search and/or multi-word word wheeling (e.g., to facilitate inputting search text), and are both based on language models (or indexes) that can rank web pages and queries according to popularity criteria, or predetermined measure. The ranking can be at least partially based upon a utility-based analysis where cost of making an incorrect decision is factored with taking automated action. In general, a non-local version of such applications can interact with one generic language model, and search or word-wheeling will therefore supply different answers to the same input based upon location—(e.g., different results are obtained when a user initiates a same query from Seattle versus New York.) For example, a user in Seattle searching on “zoo” will obtain a map of the Seattle Woodland Park Zoo, while a user in New York will obtain a map of the Central Park Zoo.

FIG. 7 illustrates a tree structure 700 that includes root node 702 corresponding to the world (however, the root node 702 can correspond to something other than the world, such as, for example, a zip code, a city block, a state, country, a galaxy, the universe), and child node(s) 703, 704, 706, 707, and 710 in accordance with a particular aspect of the subject innovation. A node or leaf can represent maps or queries issued from a region that is identifiable by longitude(s) and latitude(s) that define the region (e.g., in the form of a rectangle.) The tree structure 700 can subsequently be smoothed via moving queries in between nodes (e.g., from 707 to 704, then from 704 to 703, and from 703 to 702) based on a significance criteria, wherein the most general queries/elements move to top of the tree 700 (e.g., queries of interest to a substantially large users; such as a continent or a country, and the like), while queries of interest to a substantially smaller number of users (e.g., a city, neighborhoods in a city, and the like) move to lower portions of the tree. The largest scale is the top node 702, and the bottommost nodes 710, 706, and 707, correspond to the smallest scale, as in a specific object such as a bridge, a grave, a road, a school or an airport. Intermediate nodes 703 and 704 correspond to intermediate scaled areas such as continents, countries, regions, states, and counties, and the like.

The tree structure 700 can for example be in form of a Kd-tree with an enhanced smoothing in accordance with a significance criteria. The system 600 can then employ such tree structure in a word wheeling or search to produce results that are of interest locally, nationally, or internationally, for example. Hence, each node can have a language model tailored thereto based on locality, to provide k-best expansions for explicit/implicit wild cards inputted by a user.

According to one particular aspect of the subject innovation, a list of elements can be provided, wherein each element can contain: frequency, query, latitude, longitude, and other demographics. Such location tree can include a binary tree that partitions the World (or other predetermined area to be covered) into tiles. The subject innovation can alternate between splitting on latitude and longitude at different levels in the tree. A split can be created so that the sum of frequencies for the elements remains the same on both sides of the split. Accordingly, the elements can be partitioned into the leaves in the tree, according to the elements latitude and longitude. For example, leaf 710 can correspond to the Seattle area.

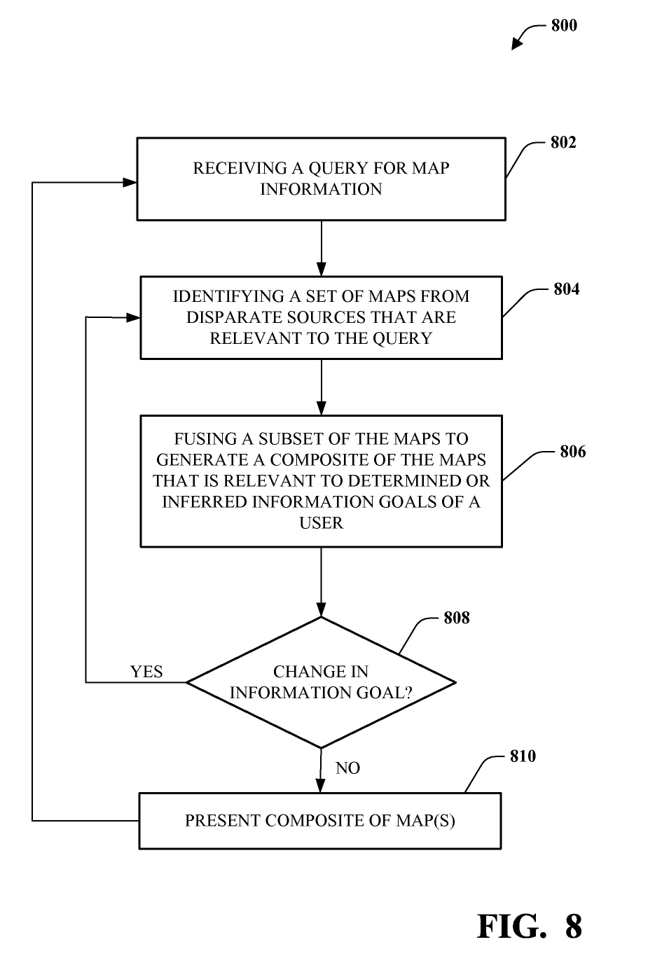

FIG. 8 illustrates a related methodology 800 in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the subject innovation. In addition, not all illustrated blocks, events or acts, are required to implement a methodology in accordance with the subject innovation. Moreover, it will be appreciated that the exemplary method and other methods according to the innovation can be implemented in association with the method illustrated and described herein, as well as in association with other systems and apparatus not illustrated or described.

At 802, a query is received in connection with a request for map-related information. The query can be received for example by user input, a computer process, a machine, or the like. The query is analyzed and processed—it is to be appreciated that historical data, user preferences, state or context information can be employed in connection with determining or inferring intent or information goals associated with the query. A search is performed based on the query and at 804 a set of maps associated with disparate sources (e.g., across a network, the Internet, a set of devices, . . . ) are identified that are relevant to the query. At 806, a subset of the maps are fused or synthesized to generate a composite of the maps (e.g., a single map that is an aggregation of the maps, a collage of the subset of maps, a most relevant sub-subset of the map . . . ). The fusing or synthesizing of the maps can be a function of determined of inferred information goals of the user. For example, maps often contact vast amounts of information and content, and the fusing process can filter out portions of such information or content that is not germane or relevant to the immediate information goals of the user.

At 808, it is determined if information goals of the user have changed. For example, if a user is moving rapidly, information goals can change at a high frequency. Accordingly, map information that has aged and is no longer relevant should not be displayed or utilized. If YES, the process returns to 804 to identify a new set of maps that are relevant to the revised information goals. If NO, at 810 the composite map information is conveyed to the user. As discussed supra, such information can be conveyed in a variety of manners or combinations (e.g., text, images, audio) as a function of user state, cognitive load, preferences, device type, device capabilities, etc.

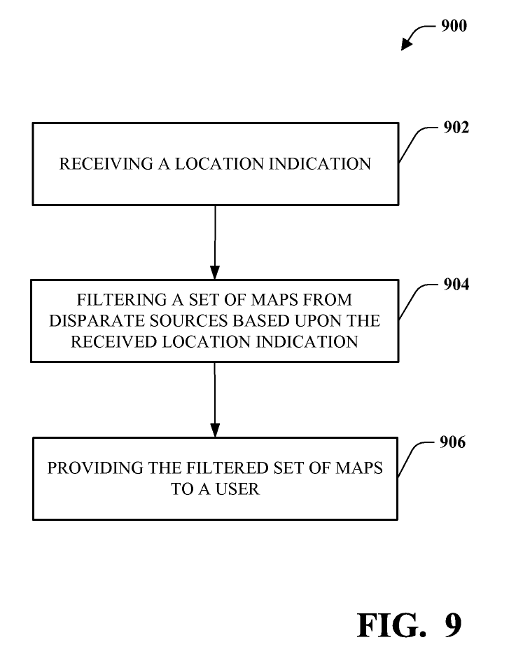

FIG. 9 illustrates a methodology in accordance with an embodiment. At 902 a location indication is received such as for example that a user is located at a particular location or is interested in a location (e.g., Seattle or New York). The location information can be received from a location identification system (e.g., GPS, wireless, proximity sensors, user input, inference, geo-tags . . . ). It is to be appreciated that distribution of maps based on geographic location represents an exemplary criteria, and other demographic criteria can also be employed for such distribution among nodes and tree formation. At 904, a set of maps is filtered based upon the received location indication. It is to be appreciated that additional filters can be employed in connection with pruning the initial set of maps to a subset of maps that are relevant to the user's information goals. For example, in addition to location, user profiles, preferences, demographics, state, map popularity, time or day, weather, traffic, newsworthy events, alarms, alerts, language, desired level of accuracy, age of information, veracity of map source, can be employed in connection with selecting suitable maps. At 906, the filtered set of map images is presented to the user. The filtered set of maps can for example be aggregated with each other or a subset thereof, overlaid upon one another, parsed, displayed as thumbnails, etc.

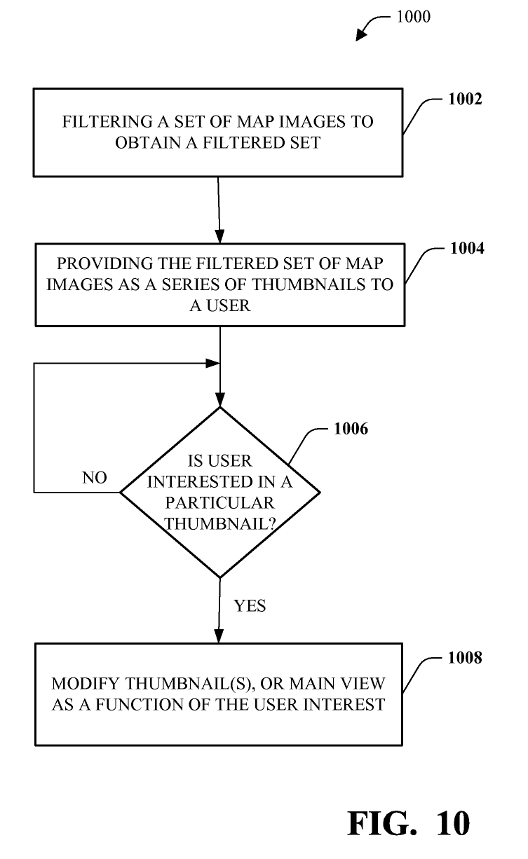

FIG. 10 illustrates an exemplary methodology 1000 in connection with thumbnails of maps. At 1002, a set of map images is filtered to obtain a subset of maps having high probability of relevance to a user's information goals. At 1004, the filtered set of map images are presented as a series of thumbnails to a user (See e.g., FIG. 5). At 1006 a determination is made whether a user is interested in a particular thumbnail or set of thumbnails (e.g., a mouse pointer is approaching a thumbnail, the user is gazing at a thumbnail, the user has indicated interest in a thumbnail, the user identified a particular thumbnail via an utterance). If the determination is “No” then the methodology returns to 1006. If the determination is “Yes,” at 1008 modification of thumbnail(s) of interest, or a main view is made as a function of the user interest. For example, the thumbnail(s) of interest can be highlighted, or opacity thereof changed. The thumbnail(s) of interest can be enlarged and made viewable in a main view. A utility-based analysis can be performed that factors cost of incorrectly taking action with respect to modification of thumbnail(s) or a main view versus the benefit associated with taking correct action. Moreover, machine learning system can be trained (explicitly or implicitly) to be fine-tuned in connection with user interaction to optimize performance of such feature as well as other features described herein. Accordingly with such training, methodologies can be performed with high levels of confidence and accuracy.

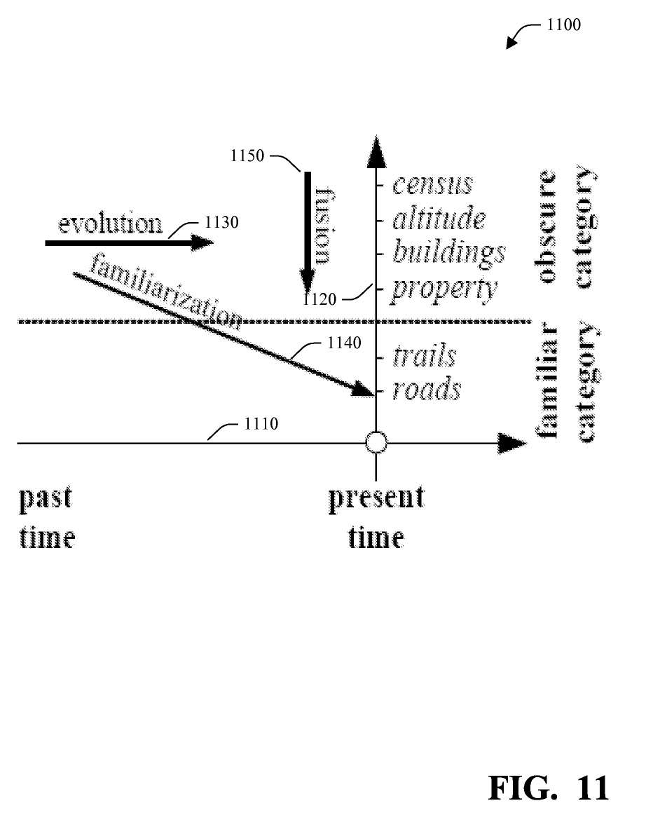

FIG. 11 corresponds to empirical data based on discussions with a plurality of map experts. A two-axis classification was performed of maps in a collection into classes of category and time. These two axes are depicted as graph 1100. Continuous time axis 1110 describes a point in time whose features the map depicts, regardless of when the map was actually drawn. A discrete category axis 1120 characterizes content of the map: the types of features depicted. Some maps depict categories of natural phenomena: water depth, tree canopy type, and bedrock composition. Others depict categories of man-made phenomena: structures, political boundaries, or demographics. A map, then, represents at least one point on this two dimensional space; a second point would represent base information. The base information is labeled as living in a “familiar” category. The herein described classification differs from conventional schemes, however, in that “location” is not placed on these axes. Computer-based map viewers have done away with some of the artificial map gutters—the seams between paper maps—that exist only as a technical limitation of paper. Some conventional map tools, for example, has a layer called “Roads” which implicitly covers multiple areas (e.g., both Seattle and Portland)—a single “map” that an archivist might have considered two distinct maps. Thus, in this model, a set of maps that have been stitched together are no longer “maps that are closely related;” they are now a single map.

Some gutters are social: even two different state highway maps may not align well at edges where they disagree about town names, highway labels, or color schemes. But in some maps such as for example the US Geological Survey (USGS) topological quadrants are parts of a larger, continuous view of data. Moving away from a notion of location-specific maps helps build a large-scale map synthesis because it can dramatically reduce number of “maps” in a collection. For example, all USGS maps of Washington State for a given year, each depicting a small area, can be merged, and thus thought of, as a single continuous map layer. This can reduce number of items that appear in a map collection index by an order of magnitude.

Further to expert interviews (task classification axes), twenty-seven distinct scenarios were described by experts and were distilled down to three major task types: familiarization 1140, evolution 1130, and fusion 1150.

Familiarization 1140 is often a first task performed in most applications of maps that relates primary features of a map to a context understood by a map user (e.g., gaining an understanding of spatial context of the map in familiar terms). This is accomplished by placing data of the map over socially understood base information. A familiar map is one that depicts a recent time and shows features from a category familiar to the user. Thus, whether a synthesis task is familiarization depends on the user's existing knowledge. Most of the tasks identified from the expert interviews were familiarization tasks, relating a map of an unfamiliar category or a past time to a recent, familiar map. This task is aided by the base information provided by the map, which provides a point of reference to the map.

One example of familiarization came from one expert who is an archivist, and who was visited by homeowners trying to determine whether their property was inside a protected watershed. The expert found a map of protected watersheds in their area. For familiarization, it also depicted coastline contours and city names, but did not show streets. The expert then found a street map of the same area and of a similar scale and helped the homeowners to synthesize the two, matching points on the unfamiliar watershed map to points on the familiar street map.

As in this example, the preponderance of familiarization reported by the experts occurred even though the origin map contained some familiarization features of its own. In some cases, the map of interest was old and its own base information was no longer appropriate for a modern audience: One expert reported that a geologist found a bedrock map with state boundaries, but wanted to relate interesting features to familiar hiking trails so she could arrange a field trip. In some cases, the familiarization features were insufficiently detailed.

Additional examples of familiarization included: relating water rights; property lines; Indian reservations to present property occupancy; discovering prior uses of property; planning a journey in an unfamiliar location or mode; planning a geology field trip; relating geographic map data to topographic maps showing hiking access; discovering historical or logging roads and railroads; traveling to historical Indian trails; learning where a grandparent lived by translating from historical landmarks to contemporary labels; finding cemeteries; studying ghost towns; finding a shipwreck; or finding a geocache site near an airstrip (“aerocaching”).

These applications of familiarization demonstrate that the “familiar” map varies by user: the familiar context ranges from roads to hiking trails to buildings to aeronautical charts. Familiarization enables the map user to take abstract data about an unfamiliar category and act on it, by navigating roads or trails, or by connecting to non-map data sources. The features on familiar maps, because they are both temporally modern and belong to widely-used categories, are well-connected to other non-spatial data (e.g., “Does that hotel next to the archaeological dig have a hot tub?”). It is interesting to note that a side-effect of a large-scale map-synthesizing interface is to make familiarization features unnecessary in most presentation maps. Once any familiar map can be visually synthesized with new maps of interest, built-in familiarization becomes redundant.

Regarding evolution 1130, the theme of studying “change across time” was ubiquitous among the experts. Evolution 1130 is broadly described as the broad category of synthesizing maps in a common category across time periods. In simple cases, such as matching a single historical map of an area with a current map of the area, the task can really be classified as familiarization. The evolution category refers more to complex queries that require a series of maps to be compared, each drawing fundamentally the same data but from a different time. For example, three experts reported serious interest in studying erosion of a shoreline by comparing a series of maps or photos that depict it.

In some cases, the evolution task is opportunistic rather than planned. That is, users of the experts' map archives sometimes came to find a single map and were surprised (and delighted) to discover a time-series of interesting maps. Thus, suggested is that a large-scale map synthesis system should both make it easy to find content related along the time axis, and easy to view an evolving time series of maps that are properly overlaid.

This is an area in particular that is serviced poorly by consumer-oriented map tools: they typically focus only on having the latest data. The major online map sites (e.g., MapQuest, Microsoft, Google, Yahoo!, etc.) all compete to have most up-to-date road maps and aerial imagery, yet none of them have an interface for accessing the enormous volume of useful, out-of-date (historical) data. Other real scenarios reported by the experts included: studying the natural meandering and human modification of streambeds, riverbeds, and canals; daylighting a stream to match its appearance prior to the Army Corps having buried it; studying erosion and modification of shorelines; relating the original plat (land division) plan for a community to its eventual development; studying the changes of counties or other political boundaries; studying changes in road and railroad networks. Because of all the different types of maps, one embodiment tracks and stores data regarding users to create user profiles that can be utilized to anticipate future actions based on past actions, and users can be prompted based on past actions or searches. For example, one embodiment prompts users to narrow their search by suggesting additionally keywords based in their particular user profile.

With regard to Fusion 1150, this last user-task category fusion, is defined as the synthesis of two maps from categories that are both unfamiliar to the user. One can consider fusion distinct from familiarization, in that the latter is the special case of placing a new map into a user's mental model of their world's geography. Fusion, on the other hand, refers to tasks whose focus is to compare two distinct datasets to each other. With fusion, the important feature is that the maps be correctly aligned relative to each other for comparison, with a lesser emphasis on familiarization's requirement that that the user understand where the aligned maps are in an absolute sense.

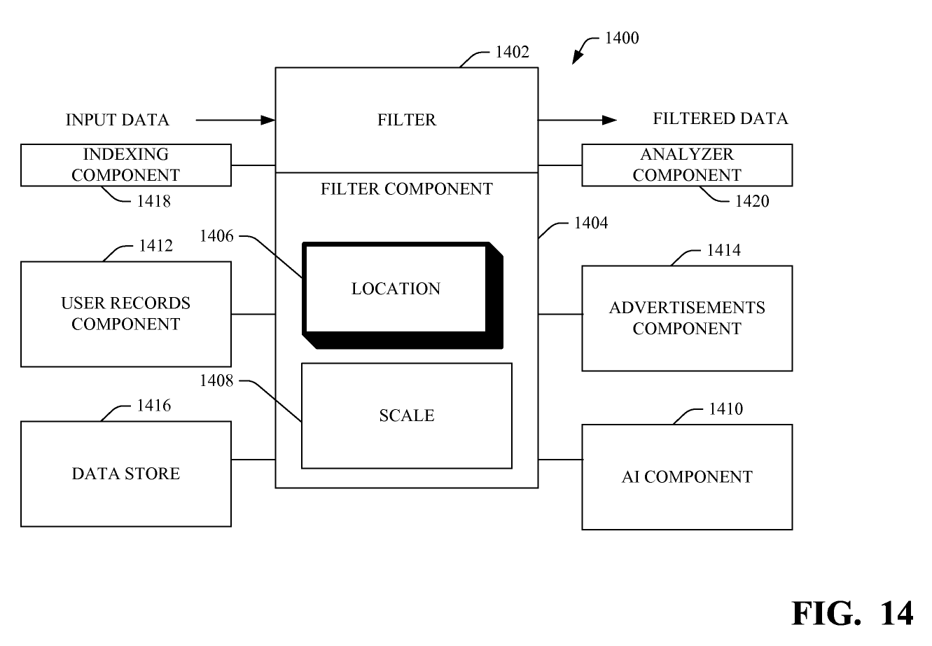

Perhaps the best-known historical example of a fusion map is epidemiologist John Snow's 1854 depiction of London, which he created to illustrate his hypothesis that a Cholera epidemic was due to a water-borne contaminant [Koch, T. 2004. The Map as Intent: Variations on the Theme of John Snow. Cartographica. 3 9:4. Winter, 2004]. The map correlated the position of Cholera patients with areas of the city served by different water sources. One can characterize this as fusion because the relationship between the illness and the water was relevant, not the absolute location of either in the world. The fusion can at least partially be effected with an AI (artificial intelligence) component 1410 (FIG. 14) selecting potential correlation candidate maps. The AI component can be employed to facilitate inferring and/or determining when, where, how to dynamically generate fusion maps from separate maps. For example, the AI component can compare maps for overlapping features (such as water source and clusters of sick people) and then generate a fusion map that a human can view. Such inference results in the construction of new events or actions from a set of observed events and/or stored event data, whether or not the events are correlated in close temporal proximity, and whether the events and data come from one or several event and data sources.

The AI component can also employ any of a variety of suitable AI-based schemes in connection with facilitating various aspects of the herein described innovation. For example, and in the context of a map layer with data in the structured query language (SQL) format, a process for learning explicitly or implicitly how a value related to a parsed SQL statement should be correlated can be facilitated via an automatic classification system and process. Classification can employ a probabilistic and/or statistical-based analysis (e.g., factoring into the analysis utilities and costs) to prognose or infer an action that a user desires to be automatically performed.

For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

The modern map experts reported that users primarily wanted to fuse two or more maps drawn from the present-day—that is, using the most up-to-date possible information. However, in some cases, users perform fusion of historical maps. For example, two experts both reported serving users who wanted to identify features seen in historical (e.g., 1930s—era) aerial photography by correlating them with maps from the same era. However, whether fusing maps from the past or present, fusion was nearly always described as across maps from the same time.

Fusion tasks reported by the experts included: an environmental study that relates ocean temperature to shoreline features; a demographic study that relates community size to the capacity of the roads leading to the community; an ethnographic study that relates census demographics to the location of hospitals and business parcels; an ecological study that relates wetland habitats, soil composition, bedrock composition, and critical areas; a study of endangered species in tidal habitats that relates bathymetric data to shoreline topography; decades-old aerial photographs are interpreted using plat maps from the same period; a bridge engineering project that relates low-resolution navigational bathymetric data to high-resolution seafloor scans; or a pollution study tracks waste flows from a shipwreck to shore using water current maps. Because of the wide range of potential fusion tasks, one exemplary embodiment tracks the users accessing of maps or searching of text and creates or maintains a user profile in order be able to make suggestions to the user.

Each map synthesis task can be characterized as a straight line within the two-axis characterization 1100 of maps. Familiarization 1140 relates any map to a map near the “origin”, evolution 1130 relates maps along the time axis holding category constant, and fusion 1150 relates maps along the category axis typically holding time constant seeking a causal relationship. However, the time can be varied while seeking a causal relationship. Although other connections could be possible, they did not occur in the interviews, surprisingly. The interviews with the experts suggested that these three categories well characterize most tasks required by actual users. A system that facilitates these three task modalities, then, should facilitate most of the tasks encountered by the real users the experts described. Just as online maps provide continuous pan and zoom that eliminate the spatial gutters between map pages, a fluid user interface to the set of all maps should eliminate the temporal and category “gutters” that separate maps.

Derived were a series of design lessons from the interviews with the experts, reflecting on both which tasks they needed, and what obstacles now block their way. The interface should support both layers that are presentation images and modern shapefile formats. There are a large number of valuable maps that have no shapefile representation. Layers should be found based on location: if a user is looking at a particular part of the world (e.g., Seattle), it should be easy to discover other layers that have detail at that location. Layers should be selectable based on scale: a user looking at the city of Seattle probably is not interested in a world map that shows per-capita income by country. Even though the world map covers Seattle, and thus matches a simple location filter, scale mismatches mean the maps are unlikely to be synthesized usefully.

Layers should be text-searchable—most layers have associated textual meta-data; in addition to the geography and scale filters, filtering based on a keyword can further narrow the search. For example and returning to FIG. 6, leaf 610 can contain all queries and respective frequencies relevant to such location. Theoretically, a language model can be built at each location, and then the proper language model can then be selected, to use according to the location of the user that inputs the text. Such approach can also be enhanced by creating an adjusted location tree, wherein distributed elements on the leaves are thinned out, by (recursively) promoting elements that are similar upwards in the tree. If the frequencies for the same query in two siblings (e.g., 606, 607) are similar—but not necessarily equal—these two elements will both be promoted to their parent in the location tree. Promotion is in this case done by deleting the elements in the siblings (the same as setting frequencies to zero) and then instead inserting the element in the parent—yet with a frequency equal to the sum of the actual frequencies in the siblings. Otherwise, if the frequencies are not similar, the sibling can be promoted with smallest frequency by inserting the element in the parent with a frequency equal to two times the smallest of the frequencies and then subtracting this frequency from both siblings (leaving the smallest frequency sibling with a zero value—and in effect deleting the element from this sibling). It is to be appreciated that in general, any reasonable test for similarity of frequencies can be employed when deciding on the promotion of siblings—and such choice can in part depend on the application.

Moreover, a “sign test” can be implemented, which returns the (one-sided) level of significance assigned to the alternative hypothesis that the smaller frequency is smaller than the higher frequency under the H0 hypothesis that they are equally likely, for example. Such (H0) hypothesis can therefore state a Binomial distribution with p=0.5, and the significance level equals the (one-sided) Binomial tail, which can be a computed tail for smaller frequencies (<=50). For higher frequencies, the binominal distribution can be efficiently approximated by a Normal distribution. Accordingly, the significance level can decide the degree of promotion of elements from more local nodes (e.g., 606, 607) toward more global nodes (e.g., 204) (from leafs towards the root). With a smaller significance level it is harder to violate the H0 hypothesis that two frequencies are similar, and elements are in this case more likely to move upwards in the location tree. A single significance level can be employed for typically all tests in the location tree. The significance level can be adjusted in a Bonferroni-like style by using the significance level adjustment:

$$α ( D ) = 1 - {0.95}^{( \frac{1}{{2}^{( D - 1 )}} )}$$

where α is the chosen significance level and D is the depth in the tree, e.g.:

α(1)=0.05

α(2)=0.0253

α(15)=3.13e−6

Given the re-distribution of elements according to the above promotion scheme, a language model can be created for each node in the location tree. For a small significance level, the language models at the nodes can typically be substantially small and contain only truly local information. As one moves up in the tree, the language models cover larger areas and the root will contain information that is equally likely no matter the location. For instance, the query “pizza” will likely appear at the root, whereas “Joe's Pizza Joint” that is specific to a locality will appear in the leaf corresponding to the location of this very specific pizza place.

The location tree can have a language model at each node in the tree. Each of these language models can be of the same type as for the generic/non-local—yet the individual models are typically substantially smaller. Accordingly, the location tree of language models can retrieve the k best matches to a text input. For example, given a particular location, the subject innovation can find the k best matches and their frequencies in every node on the path from the root to its leaf-tile. Some of the k best matches can be the same across different nodes (and some may not.) For all unique matches in this set of matches the frequencies can be added, and discounted for the frequencies obtained at intermediate nodes in the localization tree to reflect the average contribution on the specific location. Such discounted frequency can be computed as

Frequency<−frequency/(2̂L),

where L is the length of the path from the intermediate node to the leaf.

As explained earlier, the subject innovation is not limited to geographical location, and other criteria such as time, time and space, and other demographic criteria can be employed. Adjusted tree locations can also be employed in conjunction with other location identifying systems such as G.P.S, virtual earth, and the like. Layers should be quickly preview-able: when a user is exploring a large corpus, many maps will often still match the geography and scale filters. Therefore, seeing a map preview should be very fast and fluid, allowing a user to make a quick decision about relevance. Map previews serve a purpose analogous to thumbnails in an image search engine. Maps should be easily comparable: once maps of interest have been identified, the user should be able to visually manipulate them to achieve the best possible synthesis.

Please note that existing software designed for exploration of map layers often lacks many of these features. For example, Google Earth [Google Earth version 4.2 from http://earth.google.com] is currently in wide use by enthusiasts to share geographic data. Overlays are not discoverable from within the application; rather, users must find new layers using text search in an external search engine. These queries are based on textual metadata; there is no automatic way for the search engine to restrict its results based on the user's viewing location or the current map scale. Quick previews are not possible: the entire file describing the layer must be web-downloaded and imported into Google Earth before it can be seen, requiring the user to switch back and forth between the web browser and map application. While Google Earth does have limited support for image overlays, they must be smaller than 2000×2000 pixels and drawn in a cylindrical projection. In contrast, presentation maps often have detail requiring scans of 10 and even 100 times that size, and are drawn in dozens of different non-cylindrical projections.

There are millions of presentation maps that already exist, and the thousands more that are being produced each day: both new maps and scans of historical paper maps. The data they contain is unlikely to be translated into a shapefile format. As a result, when they are shared online, presentation maps are typically treated as any other bitmap on the web; their geospatial properties are not yet well exploited. This makes synthesis difficult. Embodiments described herein allow for integration between presentation maps, which dramatically reduces cost of posting maps online in a format that is rapidly accessible and preserves the geospatial relationship between each newly-posted map and every other online map. After a user manually indicates several correspondence points between features on the input map and a reference to ground-truth, the system re-projects an input map into a (cylindrical) Mercator projection and slices it for example into 256×256 pixel image tiles, making it compatible with web-based mapping systems such as Microsoft Virtual Earth and Google Maps.

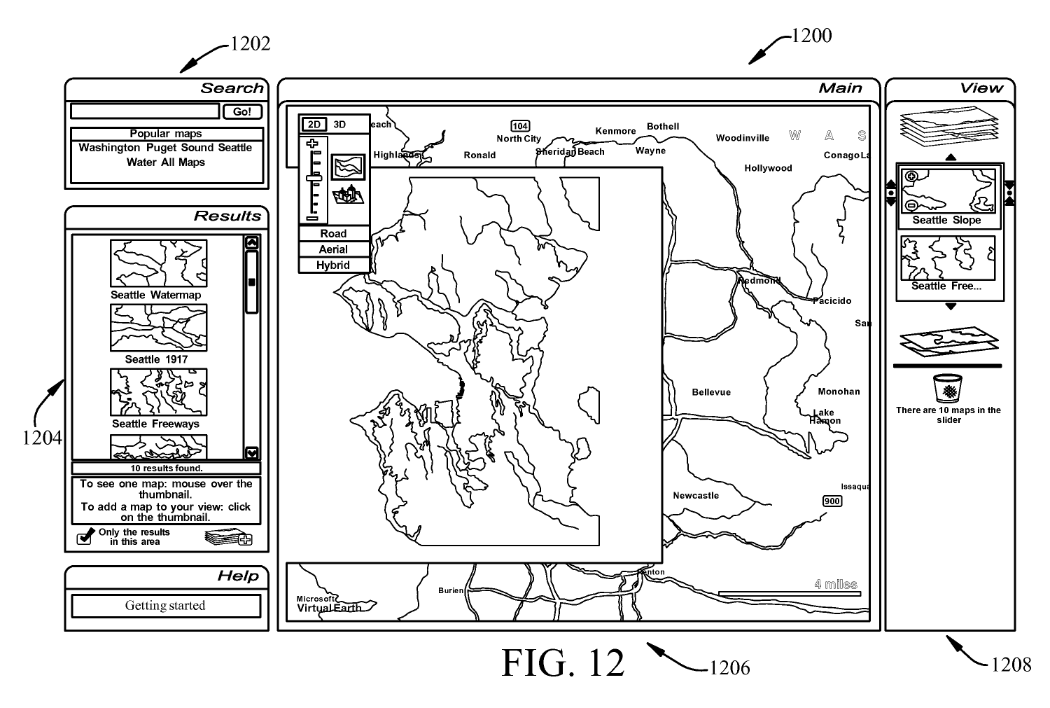

Referring to FIG. 12 a browser-based interface 1200 works left-to-right. A Search Panel 1202, top left, enables the user to discover maps by search keyword or popular tags. In the current implementation, the tags are hand-created; as the collection grows, however, they will be automatically collected from the names of the maps. Maps that match the search criteria appear in a Results Window 1204, center left, as a scrollable list of map thumbnails. Each thumbnail is captioned with the map's name. Searches can be limited to current location and scale of the map view in the Map Window 1206 (center). If keywords are left blank, the Results Window 1204 contains all maps that match the current view's location and scale. A right side portion 1208 can also hold maps and is called a View Window. The Map Window allows the user to fluidly pan and zoom around the map, showing whatever layers are currently visible.

Hovering the mouse over a thumbnail in the Results Window 1204 displays a preview. The selected map is overlaid over the main Map Window 1206, which is re-centered over the selected map. When the mouse leaves the thumbnail, the Map Window 1206 snaps back to the user's last context. This feature makes it easy for a user to quickly preview each map in the Results Window 1204 as she is scrolling through the results list.

When the user clicks on a map from the Results Window 1204, that map is pushed into the View Window 1208. The user can continue searching in the Search Window, and selecting maps in the Results Window 1204, to push as many maps as desired into the View Window 1208.

The maps in the View Window 1208 can be further manipulated to make synthesis easier. The order of the thumbnails in the View Window 1208 reflects the z-order of the maps in the Map Window 1206. The user can reorder the maps in the Map Window 1206 by dragging the thumbnails up or down in the View Window 1208. Controls on each map in the View Window 1208 also allow its transparency to be adjusted, allowing maps deeper in the stack to be visible behind maps that are above. The View Window 1208 also has an adjustable-size view port. That is, the user can choose to view all maps in the View Window 1208 simultaneously, or only two or three at a time.

With respect to synthesis tasks with the View Window 1208, the MapSynthesizer's View Window 1208 facilitates all three of the synthesis tasks described in the previous sections. For familiarization, the user places an obscure map over a familiar map in the View Window 1208. Layered maps are shown in the same coordinate system; the user can readily peek under the topmost layer by pushing the map out of the context window onto the top pile, or see through any layer by reducing a layer's opacity. Both techniques enable the user to relate features between two maps by their spatial positions. In one embodiment an optimizer component optimizes the relation of features between the two maps.

Fusion works similarly: the user finds one map first, and adds it to his working context View Window 1208. A second map in a different category can be discovered using the “search only results in this area” combined with a keyword or tag search. Fusing many categories can lead to a cluttered display; to tidy it up, the View Window has room for only a few maps. When the stack is scrolled down, maps fall off the bottom onto a “bottom pile,” where their order is preserved, but the maps are hidden from the Map Window 1206 until they are scrolled back onto the stack. When the stack is scrolled up, a map flips up onto a symmetric “top pile” (hidden but still ordered), and the top map on the bottom pile takes the empty space at the bottom of the stack.

The same View Window 1208 also makes it easy to view map evolution. The user can discover a group of results in the same category but from different periods. That group of results can be added en masse to the stack and ordered temporally. The user can drag a knob to reduce the visible region of the View Window 808 to just a single map, pushing all others into the top or bottom piles. Now, as the user scrolls up and down through the stack, the Main map view 1206 flips forward and backward through time. The spatial context does not change until the user explicitly pans or zooms the main map.

The working context View Window 1208 has a single dimension, but works well for all three common task modalities because each modality explores the space of maps along a one dimensional vector: category, time, or the special case of familiarization that connects just two maps. Thus the MapSynthesizer interface directly represents the exploration space: two spatial dimensions in the Main map window 1206, plus an additional dimension, which varies according to task, represented by the working context View Window 1208 and the z-order of the maps in the Main map window 1206. In one embodiment an optimizer component optimizes the z-ordering with respect to extent of view. In other embodiments, the optimizer component optimizes the z-order with respect to a factor other than view extent (e.g., speed).

Regarding technical details, MapSynthesizer was implemented entirely in JavaScript, allowing users from any platform to quickly get started without having to install any client software. This interface was designed to facilitate searches over a web-scale corpus of maps. One current implementation has a corpus of about seventy maps from Washington State Digital Archives' collection and another ten maps were added by hand to study specific layering interactions. As MapCruncher and shapefile layers tend to be readily discoverable using standard Internet search engines, it is hoped to dramatically increase the corpus available to users within the interface.

With respect to related work, the literature on map integration has addressed the notion of layering data. Integration is the problem of linking multiple data sources together. Research on integration has centered on trying to find ways to link datasets (e.g. [Beeri, C., Doytsher, Y., Kanza, Y., Safra, E., and Sagiv, Y. 2005. Finding corresponding objects when integrating several geo-spatial datasets. In Proceedings of the 13th Annual ACM international Workshop on Geographic information Systems (Bremen, Germany, Nov. 4-5, 2005). GIS '05. ACM Press, New York, N.Y., 87-96]). Integration researchers are interested in reconciling databases that are inconsistently or incompletely coded between coders or sources. MapCruncher sidesteps the problem of integration by merging presentation map versions as data layers. These images have some disadvantages—for example, they cannot be queried as relational database entries—but they do provide an efficient approach to making the data available, no matter what form was originally supplied.

As mentioned above, a broad variety of tools support a notion of data layers that can be added to a base map, and can be rendered in a variety of different ways. While this use of layers is common, there appears to be less research in the space of manipulating layers. Past research has noted that map experts showed greater skill than beginners in selecting multiple data layers [McGuiness, C., van Wersch, A., and Stringer, P. 1993 User Differences in a GIS environment: A protocol study. Proceedings of the 16^{th} Conference of the International Cartographic Association. May 3-9, Cologne, Germany. 478-485. Cited in MacEachren (2004)]. Beginners added more layers to their maps and had more difficulty finding their desired information on the maps. But the interfaces themselves seem less well-studied.

Cutting between multiple layers was a primary aspect of the Magic Lenses toolkit [Stone, M. C., Fishkin, K., and Bier, E. A. 1994. The movable filter as a user interface tool. In Proceedings of the SIGCHI Conference on Human Factors in Computing Systems: (Boston, Mass., United States, Apr. 24-28, 1994). CHI '94. ACM Press, New York, N.Y., 306-312]: visual “magic lens” would show a second view, metadata, or a zoomed view of a specific region of an image. Magic lenses, however, assume that the data is meaningfully available to an entire area, and that there would be a reasonably small number of lenses available.

The classic way of handling multiple maps is exactly that described by the archivists and librarians interviewed: users spread out a variety of maps on a large table surface, comparing areas and looking for correlations.

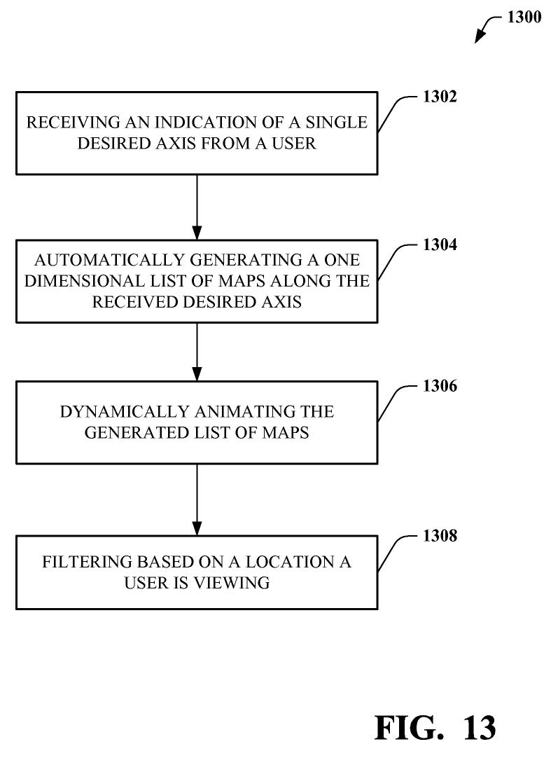

FIG. 13 illustrates a related methodology 1300 in accordance with an aspect of the subject innovation. Initially, and at 1302 an indication is received of a single desired axis from a user. It is to be appreciated that distribution of maps based on a desired axis represents an exemplary criteria, and other demographic criteria can also be employed for such distribution among nodes and tree formation. At 1304, a one dimensional list of maps along the received desired axis is automatically generated. At 1306, the generated list of maps is dynamically animated. At 1308, filtering is performed based on a location that a user is viewing. By animating the generated list it is meant to sequentially display the maps as a series of images.

FIG. 14 illustrates a system 1400 with a filter apparatus 1402 that receives input data and outputs filtered data. The filter apparatus 1402 can be a filter component 1404 that filters based on location 1406 and\or scale as explained herein. An AI component 1410 is available to infer as described above. The AI component can be employed to facilitate inferring and/or determining when, where, how to dynamically generate fusion maps from separate maps. For example, the AI component can compare maps for overlapping features (such as water source and clusters of sick people) and then generate a fusion map that a human can view. Such inference results in the construction of new events or actions from a set of observed events and/or stored event data, whether or not the events are correlated in close temporal proximity, and whether the events and data come from one or several event and data sources.

In the herein described methods and apparatus, considered was the design of a user interface that is centered on the task of correlating maps from a large corpus. Although many extant systems support layering of map data, few of them have interfaces that make discovery and manipulation of layers easy, especially as the corpus grows large. The data (filtered and unfiltered) can be stored in a data store 1416. User records can be stored in the data store 1416 and a user records component 1412 can be employed to facilitate providing targeted advertisements to the user based on her individual history. The targeted ads can be managed by an advertisements component 1414.

In one embodiment, the advertisements component 1414 tracks which ads were successful (the user clicked on the ad) and dynamically alters the earlier selection method. In other words, an initial ad selection process is employed, and then from feedback from the user, the ad selection process is altered such that the user click rate is improved. The feedback can be implicit and/or explicit. An indexing component 1418 can be employed to index results, searches, ads, etc. An analyzer component 1420 can be employed to analyze the results of ads and searches. The ads can be directed toward shopping or entertainment activities such as sporting events or new movies.

Search accuracy can be improved by the user records component 1412 tracking what the user is doing. Additionally, search accuracy can be improved by the user records component 1412 tracking what other users are doing. For example, a famous entertainer may be in the news and many people are searching for the latest story. In one embodiment, the analyzer component 1420 analyzes the users location and can make location specific decisions. For example, the user can be in a car and searching for “restaurants,” the system 1400 then returns a map identifying restaurants with in a certain radius of the user.

The design of the herein described synthesis-centric interface was informed by interviews with experts (map librarians, archivists, and GIS professionals) who regularly help customers answer real questions using correlated maps. The scenarios they described were distilled into a simple taxonomy of user tasks: familiarization, evolution, and fusion. The task categories suggested specific requirements for a user interface: maps should be easy to overlay using a common coordinate system; “legacy” paper maps must be supported to avoid losing centuries of historical data; maps search results should be filtered based on both structured data (map location and scale) and unstructured data (free text search); quick visual previews are often more intuitive than textual metadata to evaluate search results.

Thus, the system 1400 provides for simply and intuitively discovering new maps, and correlating them to answer familiarization, evolution, and fusion questions. The system 1400 (e.g., MapSynthesizer) takes advantage of the structure of map location and scale—to construct a framework to accelerate navigation through unstructured map metadata. It is to be appreciated that this model can be useful in other domains.

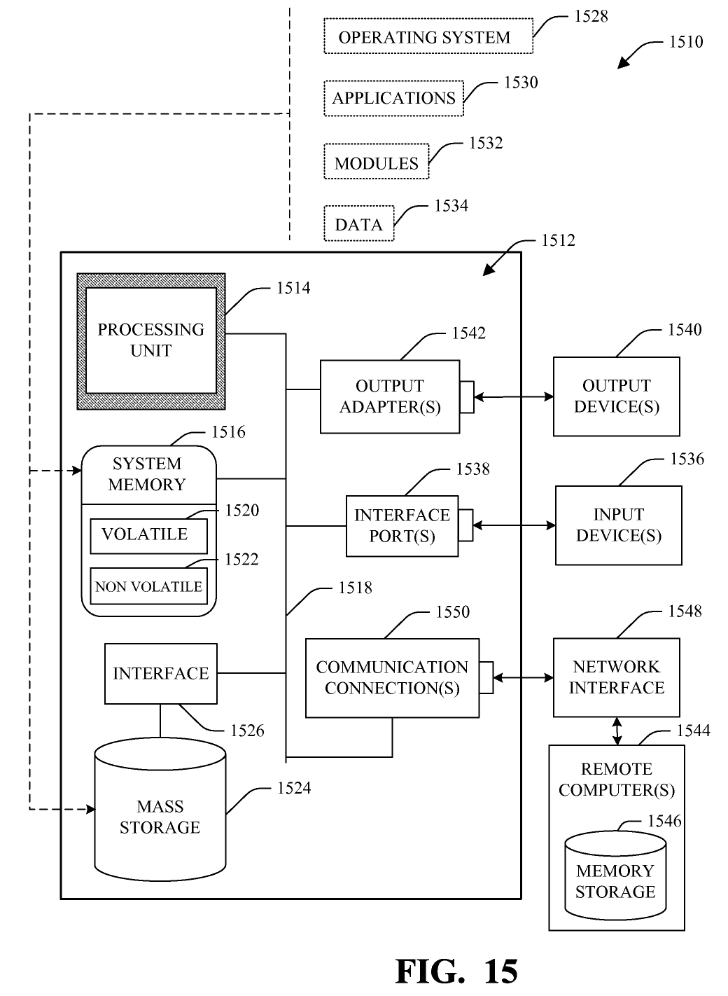

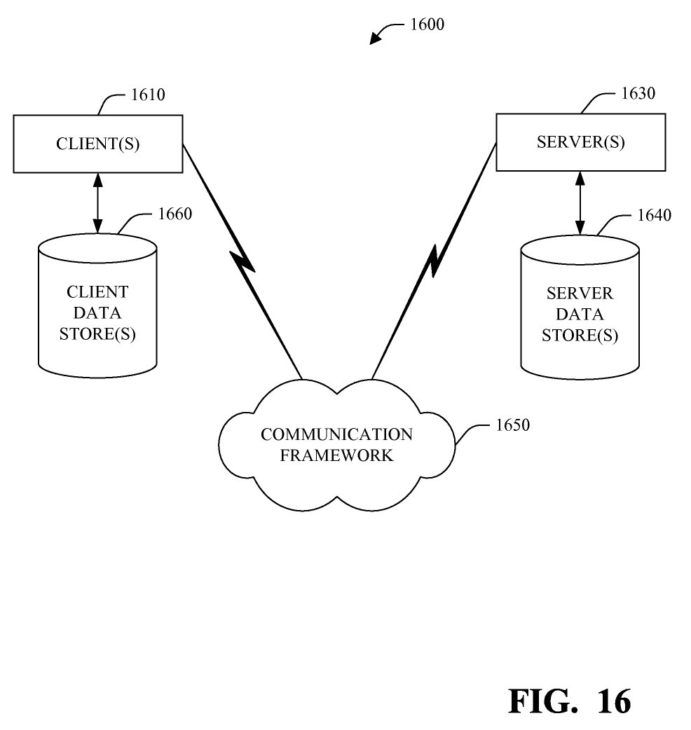

In order to provide a context for the various aspects of the disclosed subject matter, FIGS. 15 and 16 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 15, an exemplary environment 1510 for implementing various aspects disclosed herein includes a computer 1512 (e.g., desktop, laptop, server, hand held, programmable consumer or industrial electronics . . . ). The computer 1512 includes a processing unit 1514, a system memory 1516, and a system bus 1518. The system bus 1518 couples system components including, but not limited to, the system memory 1516 to the processing unit 1514. The processing unit 1514 can be any of various available microprocessors. Dual microprocessors and other multiprocessor architectures (e.g., multi-core) also can be employed as the processing unit 1514.

The system bus 1518 can be any of several types of bus structure(s) including the memory bus or memory controller, a peripheral bus or external bus, and/or a local bus using any variety of available bus architectures including, but not limited to 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1516 includes volatile memory 1520 and nonvolatile memory 1522. The basic input/output system (BIOS), containing the basic routines to transfer information between elements within the computer 1512, such as during start-up, is stored in nonvolatile memory 1522. By way of illustration, and not limitation, nonvolatile memory 1522 can include read only memory (ROM), programmable ROM (PROM), electrically programmable ROM (EPROM), electrically erasable ROM (EEPROM), or flash memory. Volatile memory 1520 includes random access memory (RAM), which acts as external cache memory.

Computer 1512 also includes removable/non-removable, volatile/non-volatile computer storage media. FIG. 15 illustrates, for example, mass, or auxiliary storage 1524. Mass storage 1524 includes, but is not limited to, devices like a magnetic disk drive, floppy disk drive, tape drive, Jaz drive, Zip drive, LS-100 drive, flash memory card, or memory stick. In addition, mass storage 1524 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the mass storage devices 1524 to the system bus 1518, a removable or non-removable interface is typically used such as interface 1526.

It is to be appreciated that FIG. 15 describes software that acts as an intermediary between users and the basic computer resources described in suitable operating environment 1510. Such software includes an operating system 1528. Operating system 1528, which can be stored on mass storage 1524 and loaded to system memory 1516, acts to control and allocate resources of the system 1512. System applications 1530 take advantage of the management of resources by operating system 1528 through program modules 1532 and program data 1534 stored either in system memory 1516 or on mass storage 1524. It is to be appreciated that the subject innovation can be implemented with various operating systems or combinations of operating systems.

A user enters commands or information into the computer 1512 through input device(s) 1536. Input devices 1536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1514 through the system bus 1518 via interface port(s) 1538. Interface port(s) 1538 include, for example, a serial port, a parallel port, a game port, and a universal serial bus (USB). Output device(s) 1540 use some of the same type of ports as input device(s) 1536. Thus, for example, a USB port may be used to provide input to computer 1512 and to output information from computer 1512 to an output device 1540. Output adapter 1542 is provided to illustrate that there are some output devices 1540 like displays (e.g., flat panel, CRT, LCD, plasma . . . ), speakers, and printers, among other output devices 1540 that require special adapters. The output adapters 1542 include, by way of illustration and not limitation, video and sound cards that provide a means of connection between the output device 1540 and the system bus 1518. It should be noted that other devices and/or systems of devices provide both input and output capabilities such as remote computer(s) 1544.

Computer 1512 can operate in a networked environment using logical connections to one or more remote computers, such as remote computer(s) 1544. The remote computer(s) 1544 can be a personal computer, a server, a router, a network PC, a workstation, a microprocessor based appliance, a peer device or other common network node and the like, and typically includes many or all of the elements described relative to computer 1512. For purposes of brevity, only a memory storage device 1546 is illustrated with remote computer(s) 1544. Remote computer(s) 1544 is logically connected to computer 1512 through a network interface 1548 and then physically connected (e.g., wired or wirelessly) via communication connection 1550. Network interface 1548 encompasses communication networks such as local-area networks (LAN) and wide-area networks (WAN).

Communication connection(s) 1550 refers to the hardware/software employed to connect the network interface 1548 to the bus 1518. While communication connection 1550 is shown for illustrative clarity inside computer 1516, it can also be external to computer 1512. The hardware/software necessary for connection to the network interface 1548 includes, for exemplary purposes only, internal and external technologies such as, modems including regular telephone grade modems, cable modems, power modems and DSL modems, ISDN adapters, and Ethernet cards or components.

FIG. 16 is a schematic block diagram of a sample-computing environment 1600 with which the subject innovation can interact. The system 1600 includes one or more client(s) 1610. The client(s) 1610 can be hardware and/or software (e.g., threads, processes, computing devices). The system 1600 also includes one or more server(s) 1630. Thus, system 1600 can correspond to a two-tier client server model or a multi-tier model (e.g., client, middle tier server, data server), amongst other models. The server(s) 1630 can also be hardware and/or software (e.g., threads, processes, computing devices). The servers 1630 can house threads to perform transformations by employing the subject innovation, for example. One possible communication between a client 1610 and a server 1630 may be in the form of a data packet transmitted between two or more computer processes.

The system 1600 includes a communication framework 1650 that can be employed to facilitate communications between the client(s) 1610 and the server(s) 1630. The client(s) 1610 are operatively connected to one or more client data store(s) 1660 that can be employed to store information local to the client(s) 1610. Similarly, the server(s) 1630 are operatively connected to one or more server data store(s) 1640 that can be employed to store information local to the servers 1630. By way of example and not limitation, the anonymization systems as described supra and variations thereon can be provided as a web service with respect to at least one server 1630. This web service server can also be communicatively coupled with a plurality of other servers 1630, as well as associated data stores 1640, such that it can function as a proxy for the client 1610.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim. The word “exemplary” is used herein to mean serving as an example, instance, or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

What is claimed is:

1. A computer-implemented map system, comprising:
a query component that generates a query for map information based on received input;
a search component that executes the query across a plurality of disparate sources of map information; and
a fusion component that fuses a subset of search results to generate a composite map view.

2. The system of claim 1, the fusion component aggregates of synthesizes a set of retrieved maps to generate a single map for displaying to a user.

3. The system of claim 1, comprising an analysis component that analyzes the input or a reformulation thereof, and determines or infers user intent or goals with respect to the input.

4. The system of claim 1, comprising an indexing component that indexes respective sources of map information to facilitate accurate and efficient retrieval of map information.

5. The system of claim 1, comprising a device control component that identifies type and capabilities of a device used in connection with the system so that the system can generate a map view as a function of type and capabilities of the device.

6. The system of claim 1, comprising a location component that determines or identifies user's physical location or user's view context; the system selects maps for fusing or displaying as a function of the user's physical location or user's view context.

7. The system of claim 1, comprising a filter component that filters maps from the search results to generate a subset of relevant maps, the filtering is performed as a function of user preferences, user context, user state, or historical information.

8. The system of claim 7, the filtering is performed as a function of user's physical location or user's view context, map scale, or device screen real-estate.

9. The system of claim 1, comprising an artificial intelligence (AI) component that infers user intent or goals in connection with obtaining map information.

10. The system of claim 8, the AI component employing a utility-based analysis where cost of providing potentially incorrect map information is weighed against the benefit of provided relevant map information.

11. A computer-implemented method, comprising:
receiving a query for map information;
identifying a set of maps from disparate sources that are relevant to the query; and
fusing a subset of the maps to generate a composite map for displaying to a user.

12. The method of claim 11, the fusing comprises extracting non-relevant data from the subset of maps.

13. The method of claim 12, the fusing comprises overlaying information from different maps within the composite map.

14. The method of claim 11, comprising displaying a set of thumbnails corresponding to the respective maps relevant to the query.

15. The method of claim 14, comprising modifying the composite map as a function of user interest or selection of one or more thumbnails.

16. The method of claim 11 comprising updating the composite map as a function of determined or inferred change in user intent or goal.

17. The method of claim 14, comprising receiving an indication of interest of a particular thumbnail and displaying the particular map indicated by the thumbnail in a main viewing window.

18. The method of claim 14, comprising dynamically changing opacity of map data based on proximity of a pointer to the thumbnail.

19. The method of claim 11, comprising displaying advertisements as a function of the fused map information.

20. A computer-implemented system for displaying a series of maps, the system comprising:
means for receiving location information;
means for filtering a set of maps based upon the received location information, and on scale;
means for providing the filtered set of map images as a series of thumbnails to a user;
means for receiving an indication of interest of a particular thumbnail and displaying the particular thumbnail in a main viewing window; and
means for dynamically changing opacity of map information based on proximity of a pointer to the thumbnail.
